(19) United States
(12) Patent Application Publication
(10) Pub. No.: US 2009/0107977 A1
(43) Pub. Date: Apr. 30, 2009

(54) Heating device of shape memory alloy member

(76) Inventors: Kazuo Kino, Tokyo (JP); Takeshi Morita, Tokyo (JP)

Correspondence Address: JACOBSON HOLMAN PLLC, 400 SEVENTH STREET N.W., SUITE 600, WASHINGTON, DC, 20004, US

(21) Appl. No.: 12/289,008

(22) Filed: Oct. 17, 2008

(30) Foreign Application Priority Data
Oct. 26, 2007 (JP) JP 2007-278981

(51) Int. Cl. H05B 1/00

(52) U.S. Cl. 219/240; 219/221; 219/250

(57) ABSTRACT

To provide a heating device of a shape memory alloy member that requires only setting a minimum level value of, for example, the diameter of a wire, does not depend on the other conditions such as the length of the wire, and hence can be easily used. A heating device of a shape memory alloy member that passes current through a member made of a shape memory alloy and works the member into a target shape by generated heat is provided with: a voltage limiting part 21 and a current limiting part 22 for outputting electric power supplied from a power supply part 20 as desired direct current power; a CPU 24 for outputting an electric power level set by an output regulator 23; a multiplier 25 for multiplying an output voltage value of the voltage limiting part 21 by an output current value of the current limiting part 22; and a comparator 26 for comparing an output of the CPU with an output of the multiplier to control an output of the power supply part, so as to output constant direct current power irrespective of an increase or decrease in load resistance.

### BACKGROUND OF THE INVENTION

1. Field of the Invention

The present invention relates to a heating device of a shape memory alloy member that passes current through a member made of a shape memory alloy and which works the member into a target shape by the generated heat.

2. Description of the Related Art

A shape memory alloy is an alloy of the type in which even if the alloy is changed in shape at a certain temperature, when the alloy reaches a shape memory temperature, the alloy is returned to an original shape, and includes, for example, a Ni—Ti alloy, and is used for micro-driving mechanical elements or for holding the shape of clothes. In an orthodontic device disclosed by JP-A-2004-65814, a shape memory alloy is used for a fastening part and is held in an expected shape by a body temperature. To make a wire made of a shape memory alloy memorize a desired shape is performed in a state where the wire has current passed therethrough to be heated by generated joule heat. However, the shape memory alloy is not constant in a change in electrical resistivity at the time of phase transformation, so that the shape memory alloy needs to be adjusted according to a member into which the shape memory alloy is worked.

An example of an element using a shape memory alloy is disclosed in JP-A-2000-121451. However, this example is a wire of composite structure in which a pipe made of a shape memory alloy has a resistance heating wire inserted and hence becomes large in the diameter of the wire, so that the example is limited in application. Further, this example needs a device different from a usual heating device. A conventional heating device for dental use employs a constant current drive system and needs to have various conditions inputted thereto in advance, the conditions including, for example, the length and diameter of a wire. When the length of the wire needs to be increased or decreased in this device, a control value needs to be inputted again in each case, which raises the problem of requiring a troublesome work for readjustment.

### SUMMARY OF THE INVENTION

The present invention has been made in view of the above-mentioned point. An object of the present invention is to provide a heating device of a shape memory alloy member that can keep constant power by setting, for example, a level value for the diameter of a wire, that is, by making a minimum level setting without depending on other conditions including the length of the wire and the like, and which hence can be easily used. Moreover, another object of the present invention is to provide a heating device of a shape memory alloy member that can easily provide a certain electric power level of work quality and which can exert effectiveness in the working of an orthodontic wire.

To solve the above-mentioned object, the present invention is a heating device of a shape memory alloy member that passes current through a member made of a shape memory alloy and which works the member into a target shape by generated heat, the heating device including: a voltage limiting part and a current limiting part for outputting electric power to be supplied from a power supply part as desired direct current power; a CPU for CPU outputting an electric power level set by an output regulator; a multiplier for multiplying an output voltage value of the voltage limiting part by an output current value of the current limiting part; and a comparator for comparing an output of the CPU with an output of the multiplier to control an output of the power supply part, wherein the heating device is constructed so as to output constant direct current power irrespective of an increase or decrease in load resistance.

The heating device of a shape memory alloy member according to the present invention targets a shape memory alloy typified by the above-mentioned Ni—Ti alloy and can be applied, in particular, to a wire and other fastening part for dental use, or also to the uses of mechanical elements for driving and of holding the shapes of clothes. The heating device of the present invention is characterized in that all that is required is to make an electric power level setting in the output regulator, which is different from a constant current drive system in the related art.

The heating device of a shape memory alloy member according to the present invention is provided with: the voltage limiting part and the current limiting part for outputting electric power to be supplied from the power supply part as desired direct current power; the CPU for CPU outputting an electric power level set by the output regulator; the multiplier for multiplying an output voltage value of the voltage limiting part by an output current value of the current limiting part; and the comparator for comparing an output of the CPU with an output of the multiplier to control an output of the power supply part.

A power supply device typified by the above-mentioned power supply part is “an AC-DC converter”, and the power supply part that is applied to the present invention constructs a device that converts a commercial AC voltage to a DC voltage and which then converts the DC voltage by a DC-DC converter. This power supply part stably supplies the set power of direct current power (DC output) through the voltage limiting part and the current limiting part.

The above-mentioned voltage limiting part limits an output voltage, and the current limiting part limits an output current, and these parts are arranged in parallel in the circuit. The output regulator is an only setting unit in the present invention and is used for setting a minimum level value of, for example, only a wire diameter. An electric power level set by the output regulator is a reference input value to be inputted to the comparator via the CPU.

The present invention is provided with the multiplier for multiplying the output voltage value of the voltage limiting part by the output current value of the current limiting part and can regulate power obtained by multiplying the voltage by the current by the multiplier. The present invention compares the output of the CPU with the output of the multiplier by the comparator and controls the output in the power supply part. Thus, the constant direct current power can be outputted irrespective of a load resistance.

Preferably, the heating device of a shape memory alloy member is built in a case having a housing part and has a flap for covering an opening of the housing part, the housing part being a receiving part of, for example, tools including pliers used for the working of an orthodontic wire, and the flap for covering the opening acting as a worktable (the invention as claimed in claim 2). In this case, the employment of a system of the type in which tools such as pliers can be fitted in and removed from a plug hole formed in the case provides a structure in which parts including a code and a plug can be received.

When the device of the present invention having the above-mentioned circuit construction is used, the device shall appropriately conduct an operation management by control software so as to perform the following operations of:
a) setting upper limits for the output voltage value and the output current value to prevent the output from going out of control;
b) detecting the hands of an operator by a detection part such as an infrared sensor or a touch sensor to control an operation to enable the operator to concentrate on the operation;
c) detecting that a tool is opened or closed, stopping the operation when the tool is opened, and protecting a heating device from over-current when the tool is short-circuited;
d) detecting an increase in temperature caused by continuously using the device to give an alarm by sound and light;
e) making the CPU store an electric power level value finally used and display the level value at that time when power is turned on next time; and
f) giving an alarm for indicating that the power is still turned on by sound and light after, for example, a set time of a few minutes elapses from when current is finally passed.

The present invention is constructed and operates in the manner described above. Thus, when the present invention is used, it is only necessary to set a minimum level value of, for example, a wire diameter, and even if the length of the wire needs to be increased or decreased, a control value does not need to be inputted again in each case. Therefore, it is possible to provide a heating device of a shape memory alloy member that is easily used and which is high in practical utility. Moreover, according to the present invention, it is not necessary to input the control value again, so that the operation can be advanced under a stable heating condition and hence a certain level of work quality can be easily acquired. Furthermore, according to the present invention, when the flap is closed, all parts can be smartly received in one case.

### BRIEF DESCRIPTION OF THE DRAWINGS

FIG. 1 is a perspective view to show an external appearance of an example of a heating device of a shape memory alloy member according to the present invention.

FIG. 2 is a plan view to show a state in which the flap of the heating device is opened.

FIG. 3 is a block diagram to show an example of the device of the present invention.

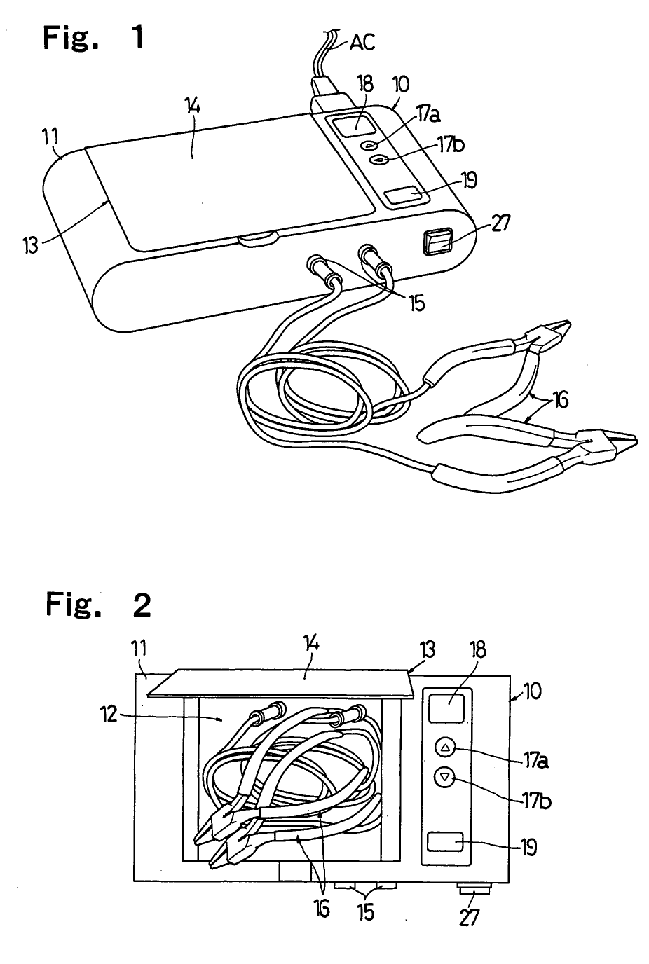

### DETAILED DESCRIPTION OF THE PREFERRED EMBODIMENTS

Hereinafter, the present invention will be described in more detail with reference to an embodiment shown in the drawings. FIG. 1 shows an external appearance of a heating device 10 of a shape memory alloy member according to the present invention, and a reference numeral 11 denotes a case, and a reference numeral 12 denotes a housing part. The housing part 12 is formed in the case 11 and is opened or closed by a flap 13. The top surface of the flap 13 is used as a worktable 14. The case 11 has plug holes 15, 15 formed in the side face thereof and has the code plugs of tools 16, 16 such as pliers connected thereto.

An operating part of the heating device 10 (not shown) of the present invention is fixed to the top face on the side of the housing part 12. The heating device 10 of the present invention is packaged in the interior on the side of the housing part 12. Setting buttons 17a, 17b of a level value to be described later and a display part 18 of an electric power level value are arranged in the operating part shown in the drawing. A reference numeral 19 denotes a detection part made of an infrared sensor.

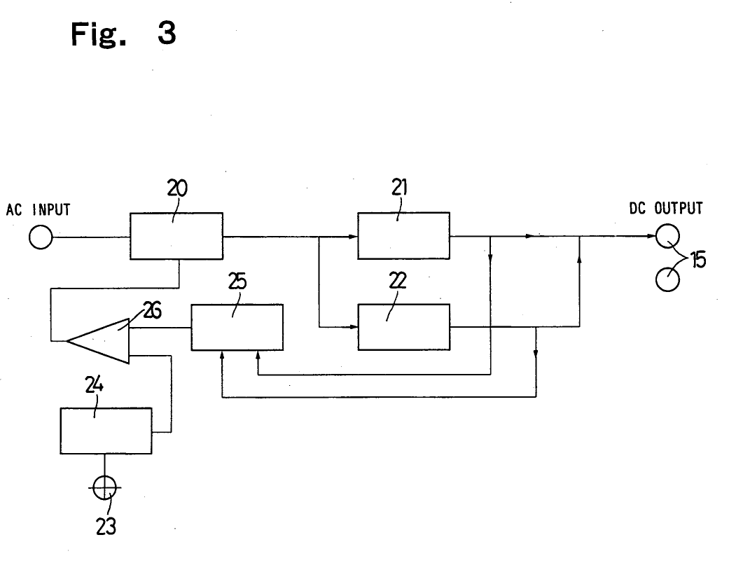

The heating device 10 of the present invention has a construction shown in FIG. 3. That is, the heating device 10 illustrated by an example is provided with: a power supply part 20; a voltage limiting part 21 and a current limiting part 22 for outputting the electric power supplied from the power supply part 20 as desired direct current power; an output regulator 23; a CPU 24 for CPU outputting an electric power level set by the output regulator 23; a multiplier 25 for multiplying the output voltage value of the voltage limiting part 21 by the output current value of the current limiting part 22; and a comparator 26 for comparing the output of the CPU 24 with the output of the multiplier 25 to control an output in the power supply part 20.

The power supply part 20 in the example shown in the drawing is constructed of an AC-DC converter and is connected to the plug holes 15, 15 of output terminals through the voltage limiting part 21 and the current limiting part 22, which are connected in parallel to each other. The voltage limiting part 21 and the current limiting part 22 are connected to the multiplier 25, and the multiplier 25 is connected to the comparator 26 along with the CPU 24. Moreover, the comparator 26 is connected to the power supply part 20. Here, the output regulator 23 is operated by the setting buttons 17a, 17b of the level value, and the level value is displayed on the display part 18.

When the heating device 10 of a shape memory alloy member according to the present invention having this construction is used, first, a switch 27 is operated to turn on the power supply part 20, and then the setting buttons 17a, 17b are operated to set the output regulator 23 at a suitable level. Here, the tools 16, 16 are detected to be opened or closed, so that when the tools 16, 16 are opened, an operation is held stopped, whereas when the tools 16, 16 are short-circuited, a protection circuit for an over-current is activated. When an operator comes to the worktable 14 with the tools 16, 16 in his hands, the operator's hands are detected by the detection part 19 such as an infrared sensor, and the heating device 10 of the present invention is started. Further, when the operator holds a wire member made of a shape memory alloy with the tools 16, 16, the electric power supplied from the power supply part 20 is outputted to the tools 16, 16 and the wire member through the voltage limiting part 21, the current limiting part 22 and the plug holes 15, 15 of the output terminals.

In this manner, the operator can bend the wire member, which is made of the shape memory alloy and has current passed therethrough to be heated to temperature suitable for a bending work, with the tools 16, 16, and the wire member memorizes a bended shape. While the operator performs this bending work, the tools 16, 16 are repeatedly opened and closed and are sometimes brought into a short-circuited state. However, it is possible to detect the state where the tools 16, 16 are opened or closed and, when the tools 16, 16 are opened, to stop the operation and, when the tools 16, 16 are short-circuited, to protect the heating device 10 from over-current. When an increase in temperature caused by continuously using the device is detected, an alarm is given by sound and light to call for attention. Not only when the work is interrupted, but even after the power supply is once stopped, the CPU 24 stores the electric power level value finally used, so that when the power is again turned on next time, the heating device 10 of the present invention is activated at the level.

The heating device 10 of a shape memory alloy member according to the present invention CPU-outputs the electric power level set by the output regulator 23 and compares the outputted level with the output of the multiplier 25 to control the output, so that the heating device 10 can keep the stable output irrespective of an increase or decrease in load resistance. Thus, after an electric power level corresponding to, for example, the diameter of the wire is set, the setting does not depend on the length of the member of the wire to be heated, so that the wire can be expected to be worked to a certain level of finishing. Here, after the work is finished, the tools 16, 16 used can have their codes removed from the plug holes 15, 15 and can be housed and stored in the housing part 12 of the case 11.

An orthodontic wire made of a so-called super-elastic type Ni—Ti alloy has an excellent spring-back characteristic and hence it is very difficult to correct the shape of the wire by bending. Thus, in some cases, a holding force applied to the mouth may be changed by hot drink to give a tightening feeling. However, by working the wire while passing current through the wire with the heating device of the present invention, it is possible to correct the shape of the wire at a transformation point of several hundred degrees of centigrade and in particular to exert a stable overheat characteristic by the CPU. Thus, it is possible to precisely work a wire having small hysteresis and also to prevent the wire from being changed in shape by hot drink or the like.

What is claimed is:

1. A heating device of a shape memory alloy member that passes current through a member made of a shape memory alloy and works the member into a target shape by generated heat, the heating device comprising:
a voltage limiting part and a current limiting part for outputting electric power supplied from a power supply part as desired direct current power;
a CPU for CPU outputting an electric power level set by an output regulator;
a multiplier for multiplying an output voltage value of the voltage limiting part by an output current value of the current limiting part; and
a comparator for comparing an output of the CPU with an output of the multiplier to control an output of the power supply part,
wherein the heating device is constructed so as to output constant direct current power irrespective of an increase or decrease in load resistance.

2. The heating device of a shape memory alloy member as claimed in claim 1, wherein the heating device of a shape memory alloy member is built in a case having a housing part and has a flap for covering an opening of the housing part, the housing part being a receiving part of an output terminal of desired direct current power and tools including pliers used for work, and the flap for covering the opening acting as a worktable.
